(19) United States
(12) Patent Application Publication
(10) Pub. No.: US 2007/0111702 A1
(43) Pub. Date: May 17, 2007

(54) SMS emergency system

(76) Inventors: Jan Sanzelius, San Francisco, CA (US); Kurt Lennartsson, Milpitas, CA (US); Ken Maley, San Francisco, CA (US)

Correspondence Address: Jan Samzelius, 3240 Lyon Street, San Francisco, CA, 94123, US

(21) Appl. No.: 11/599,912

(22) Filed: Nov. 15, 2006

Related U.S. Application Data
(60) Provisional application No. 60/737,528, filed on Nov. 16, 2005.

(51) Int. Cl. H04M 11/04

(52) U.S. Cl. 455/404.1

(57) ABSTRACT

The invention creates new technologies in the area of mobile and landline system software to prioritize certain communications traffic, in case of an emergency. The invention also creates new technologies to extract from text messages the content about local conditions, such that it can be compared with other data about the same location and included in reporting.

### CROSS-REFERENCE TO RELATED APPLICATIONS

Provisional Patent Application No. 60/737,528, filed Nov. 16, 2005.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention is in the field of providing emergency related information to citizens and to first responders. In many emergency situations, particularly natural disasters (but also man-made disasters) information flows are severely disrupted—telephone systems go down, computer networks are damaged etc. Citizens have a high need for information, particularly about the area where they live and what they should do or not do in the particular situation. For example, citizens seeking to go home need to know if roads are impassable or areas dangerous.

Similarly, first responders frequently lack information about local conditions. It can be near impossible to find out which buildings are on fire, after an earthquake. Traffic congestion can further hamper information gathering. To a Fire Department, information about what is on fire where is vital to be able to quickly allocate available resources. This invention solves both of these information needs, through the use of text messages, priority assignment of messages in the communications systems and computer software to process the local condition information.

### BRIEF SUMMARY OF THE INVENTION

The invention is in the field of providing emergency related information to a plural of primarily mobile receivers, such as cell phones (but not limited to mobile devices), where the users' registered home address is affected by the emergency or a disaster situation or to users currently located in the affected area The invention will differentiate between messages sent to phones located within the affected area (mobile phones and landlines) and to mobile phones located outside of the affected area The invention will further give higher priority to said emergency messages over concurrent communication using the same network, facilitating emergency messages to get through to effected users. The preferred message technology for the invention uses SMS messages, which requires only minimal bandwidth. For landlines the system can use CallerID (prior art) in a new inventive way to relay important messages to users.

The invention further encompasses requesting users in the area of the emergency to report local conditions via SMS and other communication means to a central location and for such reports to be compiled, interpreted, aggregated and displayed by a computer system. The output would primarily, but not exclusively, consists of maps showing local conditions to be given to first responders, agencies, as well as individuals. These SMS messages will, through changes in switching and routing software in mobile and fixed phone systems, be given priority.

### BRIEF DESCRIPTION OF THE SEVERAL VIEWS OF THE DRAWING

Not Applicable

### DETAILED DESCRIPTION OF THE INVENTION

In an emergency situation there is a need to, from a registered dispatch service, such as 911, quickly send messages to inform larger groups of people currently located in an affected area and people who has a registered home address in the area affected by the emergency or disaster. Cooperation with carriers and the dispatch service warrants that when such message is sent from the dispatch service to a receiving message system, located at each carrier, the message will be pre-processed to locate the phone numbers of cell phones for the users which has their home address registered in the affected area.

Then, as a first step, send the emergency message to only those cell phones belonging to the carrier's network, and as a second step, for users presently located in the affected area, the carriers last recognized device location (a “here I am ping” from each cell phone) is automatically registered by the carriers' cell based network within the affected area, will also be notified (roaming users).

Examples of the message are, but are not limited to, data packet based messages, such as SMS, MMS, email and a broadcast voice message. The emergency messages are given priority over currently ongoing traffic in the network. SMS (Short Message System) is the preferred method for use with the invention since it is the most efficient communication protocol (160 characters per message at the time this document is written). Text messages are also more concise than a voice message, and can be read over and over again without consuming valuable air time.

SMS has an additional advantage built in by the automated “reply?” message the user gets after reading a SMS message. Using this functionality the invention can be used to send questions from the emergency service and users can easily reply to the sender with a short efficient message. Invaluable in situations when an emergency service is trying to quickly assess an emergency situation or to help individuals located in the affected area. Responses from end users, describing local conditions, can be assembled, interpreted, aggregated and displayed by a computer system. The computer system will use linguistic and template techniques to determine the location of the respondent (unless other location information is available) and determine the conditions described. The computer system will produce different kinds of output, principally maps showing local conditions with high granularity, which can be distributed to first responders and permit them to properly allocate resources.

As mentioned above the system differentiates between messages (from the emergency service) to phones located within the affected area from phones located outside of the affected area. This is particularly important since phone users that are outside the affected area can be informed about the situation but be told to stay out of the area in order to e.g. make sure emergency vehicles can get through or if a situation occurs that involves risks for people returning to the area

In order to illustrate what we mean, we have created an imagined situation involving a derailed freight train carrying gasoline. Initially, before the emergency dispatch service have fully assessed the situation, due to the risk for explosions, a warning message to the mentioned two groups of users is warranted. We will give two examples of messages, one to be sent to the people currently located within the affected area and one to the users with home addresses in the area but that currently is somewhere else.

Example of a SMS message for phones currently located outside the area: “Warning: Derailed Train carrying Gasoline close to the area you live. Risk for explosions. Stay outside a five mile radius from home until further notification is given.”

Example of a message for people currently located inside the area: “Warning: Derailed Train carrying Gasoline in the area you are located. Risk for explosions. Stay inside and refrain from driving (stop engine) until further notification is given.”

The invention also allows messages to be sent to people with landlines through the CallerID technology by using the 15 character name field for displaying a message. Messages will then be sent as a series of short ring signals where messages will be built from displaying 15 characters snippets each time. Example: “Warning:”, “Derailed Train”, “carries Gasoline”, “in area”, “Explosions Risk”, “Stay inside”, “More Info Soon”. This technology can be used for land line phones or for phones not having messaging capabilities.

The invention permits the emergency service to request detailed information from users. In this case, users might be asked via SMS: ‘How strong is the smell gasoline, 1 to 10?’ The resulting information could be used to assemble a map of where the potential gasoline cloud currently is located and how concentrated it is.

Independent of the technology used to send messages, the invention uses broadcast technology to send messages to a large number of phones at the same time. For SMS messages to all affected users (phone numbers) can be sent at the same time. In the case of using Caller ID to broadcast messages, in order not to overload the ring signal generation at the PSTN's (Public Switched Telephone Network) local telephone exchange (for land lines), a predefined set of phone numbers are used to send a message snippet to at the same time. Then, while waiting for the user to read the first snippet, one or more new set of numbers are called (with a small timeslot in-between sets of numbers) relaying the same message until all phone numbers in the group are reached. Once completed, the system using CallerID will move on to broadcast the next snippet until the full massage has been relayed (may also be repeated). The number displayed for the CallerID is the number users can call to get additional information (automated voice message).

The invention provides a significant advantage over prior art suggesting using GPS or triangulation location system to locate each affected phone and then send messages to only those cell phones currently located in the area of the emergency. Such limitations have multiple drawbacks. First scalability, locating each cell phone in a certain area using GPS or Triangulation will require significant computing overhead at each carrier and only work for a smaller number of cell phones and carriers that can provide such services as GPS and triangulation. It is unlikely to work for roaming users that temporarily is located in another carrier's network. Furthermore few cell phones today have GPS capability and more importantly the GPS capability can be manually turned off.

The invention is aimed at overcoming these limitations by only requiring minimal investments in new systems and minimizes modifications to already available services while maximizing existing services, thereby providing a scalable and easy to implement emergency warning solution.

The invention further provides first responders local information heretofore impossible to obtain in any organized fashion. The information will dramatically increase first responder units' efficiency in emergency situations.

1. A warning system consisting of one or more computer systems linking one or more registered dispatch service organizations with new or existing computer systems at one or more cell phone carriers, such as between a 911 dispatch organizations computer system and each carrier's warning system, further processing messages to be sent through one or more a communication networks used to alert individuals through a mobile communications device in the event of an emergency and/or disaster,

2. Warning system in claim 1, to send Messages to individuals' mobile devices and landline phones with a registered home address in an affected area,

3. Warning system in claim 1 to send Messages to individuals currently located in the region affected by the emergency and/or disaster,

4. Warning system in claim 1 to customize Messages to be sent differently depending on if the phone is currently located inside the affected area or outside the area,

5. Warning system in claim 1 to prioritize the message traffic over ongoing other traffic in the network in such a way that emergency messages are given priority over ongoing traffic in the carriers network,

6. Warning system in claim 1 to request local condition reports from users and route all the replies to particular number or network location,

7. an Information Processing System to gather, interpret, analyze, collate and aggregate local condition reports in claim 6 into data pertaining to conditions at specific localities,

8. Information Processing System in claim 7 to produce reports of local condition data, often, but limited to maps,

9. Information Processing System in claim 7 to distribute such output and reports to first responders and other relevant agencies, companies and individuals.
